(19) United States
(12) Patent Application Publication
(10) Pub. No.: US 2009/0113668 A1
(43) Pub. Date: May 7, 2009

(54) Automatic Door Shutter

(76) Inventor: Chun-Ju Chen, Sikou Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/934,813

(22) Filed: Nov. 5, 2007

(51) Int. Cl. E05F 1/10

(52) U.S. Cl. 16/80

(57) ABSTRACT

An automatic door shutter is composed of a stationary plate and a pressing plate pivotally combined together to make a resilient body located therebetween. Additionally, a pivot of the stationary plate has a sliding notch accepting an S-shaped resilient sheet abutting the pressing plate. By attaching the stationary plate and sliding base to a door frame and a door board respectively, the resilient body pushes the pressing plate to shut the door board automatically. When the door board is pushing to fully open, the pressing plate pivots to the stationary plate and then the S-shaped resilient sheet slides in the sliding recess and is compressed to deform to become U-shaped one. Until the door board is fully open, the U-shaped resilient sheet causes an outward pushing force to the pressing plate to keep the door board open constantly.

### BACKGROUND OF THE INVENTION

1. Field of the Invention

The present invention relates to a door shutter, and more particularly to a door shutter that is to close a door automatically or selectively locates the door open.

2. Description of Related Art

In most occasions, keeping a door close is a polite manner and also a safety concern but most people do not have this habit and usually keep the door open or swing in the wind. Not only raising home-breaking concerns by evildoer but also reducing the adjustment efficiency of an indoor air conditioning, manufacturers develop many automatic hinges to resolves those problems. The automatic hinges drive the door to shut automatically after the door is open so that the door can be kept close always and conveniently without paying attention by users.

However, the conventional automatic hinge is attached between a door frame and a door board to practice and thus has to be prepared before is the door board is mounted to the frame so that the conventional automatic hinge can be built according to the structures of the door frame and door board. Unfortunately, most present door assemblies are plan designs in door board structure (i.e. only equipped with simple hinges) and do not have the automatic shutting efficiency, therefore, the conventional automatic hinges can not be directly applied to the door assemblies (relative locations and distance between the door board and the door frame are all factors to check whether the automatic hinges can be attached or not). When users apply the conventional automatic hinges to the door assemblies, the door boards must be detached and then modified and reformed according to the door frame and the automatic hinges. Therefore, attaching process of the conventional automatic hinge is complex and can not be accepted and performed by common users. The conventional automatic hinge is not widely utilized in household.

Other conventional automatic door shutters usually have pneumatic cylinders or hydraulic cylinders that make the cost and volume increased greatly. Therefore the conventional automatic door shutters are hardly accepted by general consumers and only limited to use in commercial sites or market buildings.

### SUMMARY OF THE INVENTION

A main objective of the present invention is to provide an automatic door shutter that is convenient to apply to assembled door assembly.

Another main objective of the present invention is to provide an automatic door shutter that selectively keeps the door open stably or closes the door automatically.

To achieve the foregoing objectives, the automatic door shutter comprises:

a stationary plate adapted to mount on a door frame and having a pivotal shaft with an outer end, and a sliding notch defined at the outer end;

a sliding base adapted to mount on a door board;

a pressing plate engaging the sliding base to adapt to mount on the door board, pivotally attaching the stationary plate, and having a front end with a sliding recess to slidably combine with the sliding base;

a resilient body attached between the stationary plate and the pressing plate to keep a reactive angle range for resilient restitution; and

an S-shaped resilient sheet having one end received inside the sliding notch of the stationary plate and another end abutting to the pressing plate;

wherein the resilient body deforms to provide restitution force to shut the door automatically after the door is pushed and the S-shaped resilient sheet is deformed to a U-shaped one exceeding the reactive angle range to push the pressing plate outward when the door is fully open.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an automatic door shutter in accordance with the present invention;

FIG. 2 is a perspective view of the automatic door shutter in FIG. 1, wherein the automatic door shutter is assembled;

FIG. 3 is a perspective view of the automatic door shutter mounted to a door assembly; and

FIG. 4 is an operational cross-sectional view of the automatic door shutter cooperating with the door assembly as shown in FIG. 3.

### DETAILED DESCRIPTION OF THE PREFERRED EMBODIMENT

An automatic door shutter in accordance with the present invention comprises a stationary plate and a pressing plate pivotally combined together to make a resilient body located therebetween to keep the stationary plate and the pressing plate in a reactive angle allowing resilient restitution. Additionally, a pivot of the stationary plate has a sliding notch defined on its outer periphery to accept an S-shaped resilient sheet abutting an inner side of the pressing plate. The pressing plate has a front end and a sliding recess defined at the front end to combine with a sliding base. By attaching the stationary plate and sliding base to a door frame and a door board respectively, the resilient body reactively pushes the pressing plate to shut the door board automatically. When the door board is pushing to fully open, the pressing plate pivots to the stationary plate and then the S-shaped resilient sheet slides in the sliding recess and is compressed to deform to be U-shaped. Until the door board is fully open, the U-shaped resilient sheet causes an outward pushing force to push the pressing plate to keep the door board open.

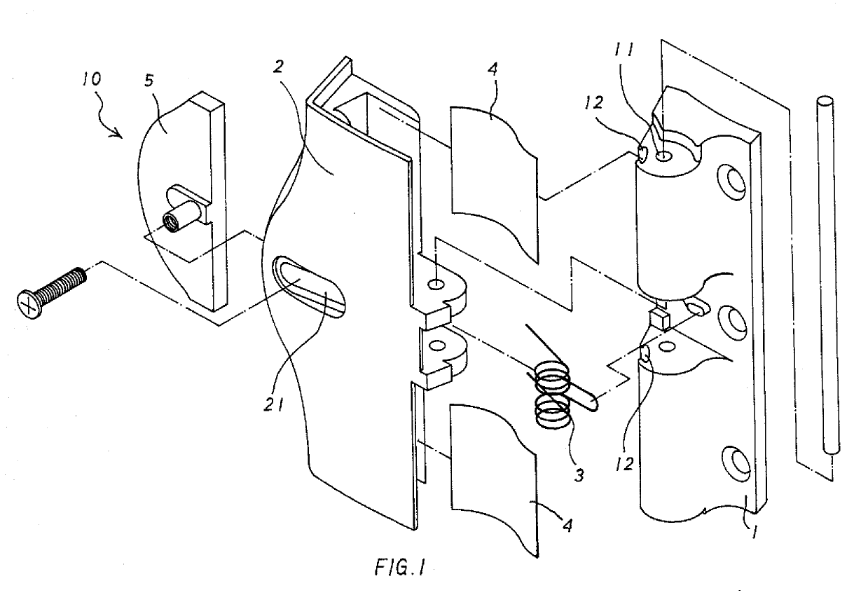

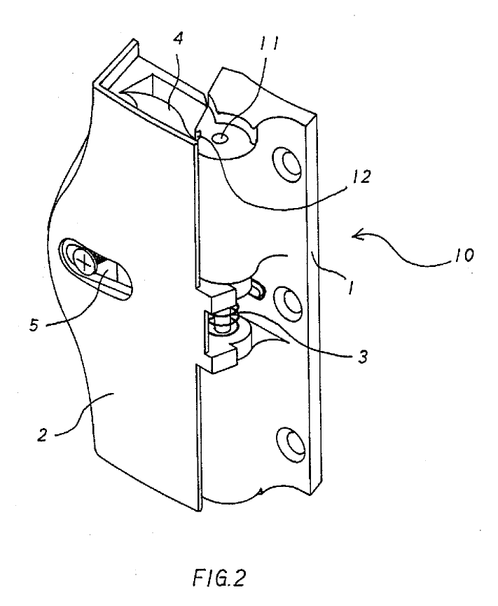

A preferred embodiment of the automatic door shutter is composed of a stationary plate 1 and a pressing plate 2 pivotally engaged together (as shown in FIG. 1) to arrange a resilient body 3 (i.e. a spring) therebetween to keep a reactive angle range for resilient restitution, wherein the spring 3 sleeves between the stationary plate 1 and the pressing plate 2 coaxially. The stationary plate 1 has a pivotal shaft 11 and a sliding notch 12 defined on an outer periphery of the pivotal shaft 11 to receive one end of an S-shaped resilient sheet 4 that also abuts an inner side of the pressing plate 2. Moreover, the pressing plate 2 has a front end and a sliding recess 21 defined at the front end to allow a bolt passing therethrough to combine slidably with a sliding base 5 to achieve the automatic door shutter in the present invention (as shown in FIG. 2).

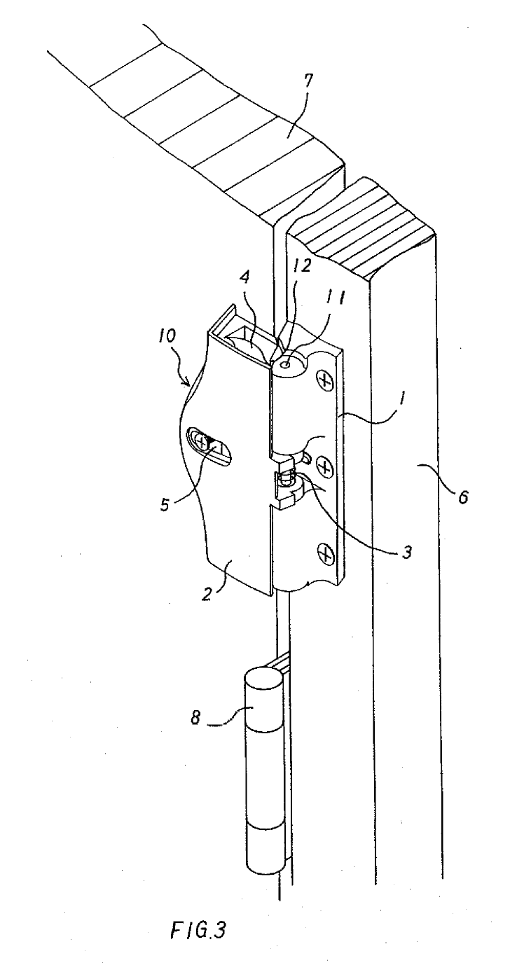

By having the foregoing elements, the stationary plate 1 is attached to a door frame 6 (as shown in FIG. 3) and the sliding base 5 is mounted on the door board 7 so that the resilient body 3 provides a resilient force to push the pressing plate 2 and then push the sliding base 5 to keep the door board 7 close constantly. When a user opens the door, a hinge 8 of the door board 7 has a pivotal center differing from one of the pivotal shaft 11 of the automatic door shutter 10 in axle so that a location bias of the door board 7 caused by rotation can be eliminated by the relative displacement of the sliding base 5 and the pressing plate 2. Therefore, the door board 7 has a smooth movement without obstruction. When the door is opened, the rotation of the pressing plate 2 makes the resilient body 3 deformed to generate more resilient deformation so that the restitution force provided by the resilient body 3 pushes the door board 7 to shut automatically when the door board 7 is released and thus the automatic shutting performance is achieved.

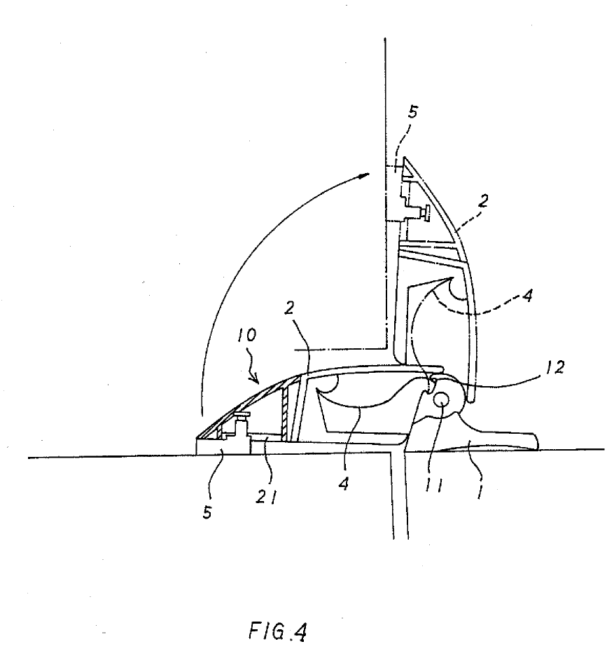

The S-shaped resilient sheet 4 has a fixed end attached to the pressing plate 2 and a movable end received inside the sliding notch 12 so as to be clamped between the stationary plate 1 and the pressing plate 2. Therefore, the S-shaped resilient sheet 4 is at a position bias to the pivotal shaft 11 of the stationary plate 1 and the pressing plate 2 and thus is driven to deform to U-shape one when the pressing plate 2 rotates. According to the FIG. 4, the U-shaped resilient sheet provides a pushing force to push the pressing plate 2 outward. Particularly, the pushing force provided by the S-shaped resilient sheet 4 is larger than the restitution force provided by the resilient body 3 to keep the door open without retrieving back by the restitution force.

When the user wants to keep the door open, the pressing plate 2 is pushed toward to the stationary plate 1 the fixed end on the S-shaped resilient sheet 4 is pulled in arc line by the pressing plate 2 and the movable end of the S-shaped resilient sheet 4 slides in the sliding notch 12 until the S-shaped resilient sheet 4 turns into U-shaped one that keeps a propping force to the pressing plate 2 (with the door board 7) to keep the door open. Until the door is fully open, the S-shaped resilient sheet 4 deformed to U-shape provides a force to push the pressing plate 2 outward. As shown in FIG. 4, the S-shaped resilient sheet 4 is substantially U-shaped and fixed in angle by a positioning structure at a pivotal combination structure of the co-axle (i.e. the pivotal shaft 11) of the stationary plate 1 and the pressing plate 2, wherein the position structure comprises two blocks respectively formed on the stationary plate 1 and the pressing plate 2. Because the U-shaped resilient sheet 4 has a resilient force (the pushing force) larger than the restitution force of the resilient body 3, the door board 7 can be kept fully open. On the contrary, when the S-shaped resilient sheet 4 is reinstated from the U-shaped deformation by slightly pushing the door board 7 to overcome a limit angle (exceeding the reactive angle range), the restitution force of the resilient body 3 drives the pressing plate 2 to shut the door board 7 automatically once again.

According to above description, the automatic door shutter in the present invention has the following advantages:

1. Because the stationary plate 1 and the sliding base 2 are respectively combined to the door frame 6 and the door board 7, the resilient body 3 provides a restitution force and then presses the pressing plate 2 on the door board 7 correspondingly connected by the sliding base 5 to shut the door board 7 automatically.

2. In the process to fully open the door, the S-shaped resilient sheet 4 slides in the sliding notch 12 and is compressed to deform into U-shaped one in along with the rotation of the pressing plate 2 because the sliding notch 12 relatively closes to the pressing plate 2. Then, the S-shape resilient sheet 4 is bent and generates a force pushing the pressing plate 2 outward (meanwhile, the S-shaped resilient sheet 14 is substantially U-shaped) to keep the door fully open. When the user pulls the door board 7 to close, the S-shaped resilient sheet 4 is reinstated from the deformation by slightly pushing the door board 7 to overcome the limit angle to eliminate the outward pushing force and thus the restitution force of the resilient body 3 drives the pressing plate 2 to shut the door board 7 automatically once again.

3. Because the stationary plate 1 and the pressing plate 2 can be attached to the door without disassembling the door frame 6 and the door board 7, applying the automatic door shutter is simple and convenient to increase utility efficiency to household. Moreover, components of the automatic door shutter are simple and low-cost so that the automatic door shutter in the present invention is popular and economically available.

Although this invention has been described in its preferred form with a certain degree of particularity, it is understood that the present invention of the preferred form has been made only by way of example and that numerous is changes in the details of construction and the combination and arrangement of parts any be resorted to without departing from the spirit and scope of the invention.

What is claimed is:

1. An automatic door shutter comprising:
a stationary plate adapted to mount on a door frame and having a pivotal shaft with an outer end, and a sliding notch defined at the outer end;
a sliding base adapted to mount on a door board;
a pressing plate engaging the sliding base to adapt to mount on the door board pivotally attaching the stationary plate, and having a front end with a sliding recess to slidably combine with the sliding base;
a resilient body attached between the stationary plate and the pressing plate to keep a reactive angle range for resilient restitution; and
an S-shaped resilient sheet having one end received inside the sliding notch of the stationary plate and another end abutting to the pressing plate;
wherein the resilient body deforms to provide restitution force to shut the door automatically after the door is pushed and the S-shaped resilient sheet is deformed to a U-shaped one exceeding the reactive angle range to push the pressing plate outward when the door is fully open.

2. The automatic door shutter as claimed in claim 1, wherein positioning device comprises two blocks respectively formed on the pressing plate and the stationary plate to keep the door board from over rotation.
